(19) United States
(12) Patent Application Publication
(10) Pub. No.: US 2009/0213492 A1
(43) Pub. Date: Aug. 27, 2009

(54) METHOD OF IMPROVING STABILITY OF DOMAIN POLARIZATION IN FERROELECTRIC THIN FILMS

(75) Inventor: Quan A. Tran, Fremont, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/035,989

(22) Filed: Feb. 22, 2008

(51) Int. Cl. G11B 5/127

(52) U.S. Cl. 360/110

(57) ABSTRACT

A memory device comprises a ferroelectric media comprising at least one ferroelectric film. The ferroelectric film has an as-grown spontaneous polarization of a first direction. A tip is position over the ferroelectric film and a first voltage is applied to the tip larger than a switching voltage of the ferroelectric film. One or both of the tip and the ferroelectric media is moved to form a first domain having a spontaneous polarization of opposite the first direction. The tip is then positioned over the first domain and a second voltage to the tip smaller than the first voltage to form a second domain smaller than the first domain and having a polarization of the first direction, the second domain defining the bit.

### BACKGROUND

Software developers continue to develop steadily more data intensive products, such as ever-more sophisticated, and graphic intensive applications and operating systems. As a result, higher capacity memory, both volatile and non-volatile, has been in persistent demand. Also adding to this demand is the need for capacity for storing data and media files, and the confluence of personal computing and consumer electronics in the form of portable media players (PMPs), personal digital assistants (PDAs), sophisticated mobile phones, and laptop computers, which has placed a premium on compactness and reliability.

Nearly every personal computer and server in use today contains one or more hard disk drives (HDD) for permanently storing frequently accessed data. Every mainframe and supercomputer is connected to hundreds of HDDs. Consumer electronic goods ranging from camcorders to digital data recorders use HDDs. While HDDs store large amounts of data, they consume a great deal of power, require long access times, and require “spin-up” time on power-up. Further, HDD technology based on magnetic recording technology is approaching a physical limitation due to super paramagnetic phenomenon. Data storage devices based on scanning probe microscopy (SPM) techniques have been studied as future ultra-high density (>1 Tbit/in2) systems. Ferroelectric thin films have been proposed as promising recording media by controlling the spontaneous polarization directions corresponding to the data bits. There is a need for techniques and structures to read and write to a ferroelectric media that facilitate desirable data bit transfer rates and areal densities.

### BRIEF DESCRIPTION OF THE DRAWINGS

Further details of the present invention are explained with the help of the attached drawings in which:

FIG. 1A is a perspective representation of a crystal of a ferroelectric material having a polarization.

FIG. 1B is a side representation of the crystal of FIG. 1A.

FIG. 2A is a side view of an embodiment of a system in accordance with the present invention comprising an electrode arranged over a surface of a ferroelectric film to prepare a portion of the ferroelectric film for writing.

FIG. 2B is a side view of a tip of the system of FIG. 2A arranged to write a bit by polarizing a domain within the prepared portion.

FIG. 3 is a flow-chart for an embodiment of a method of writing bits using an electrode in accordance with the present invention.

FIG. 4A is a side view of an alternative embodiment of a system in accordance with the present invention comprising a tip arranged over a surface of a ferroelectric film to prepare a portion of the ferroelectric film for storing information.

FIG. 4B is a side view of the system of FIG. 4A wherein a bit is written by polarizing a domain within the prepared portion.

FIG. 5 is a flow-chart for an embodiment of a method of writing bits using a tip in accordance with the present invention.

FIG. 6A is a plot of domain diameter for bits of different size written without preparing a portion of the ferroelectric film as measured over a period of time.

FIG. 6B is a plot of domain diameter for bits of different size written using an embodiment of a method of writing bits in accordance with the present invention as measured over a period of time.

### DETAILED DESCRIPTION

Ferroelectrics are members of a group of dielectrics that exhibit spontaneous polarization—i.e., polarization in the absence of an electric field. Permanent electric dipoles exist in ferroelectric materials. Common ferroelectric materials include lead zirconate titanate (Pb[ZrₓTi₁₋ₓ]O₃ 0<x<1, also referred to herein as PZT). Taken as an example, PZT is a ceramic perovskite material that has a spontaneous polarization which can be reversed in the presence of an electric field.

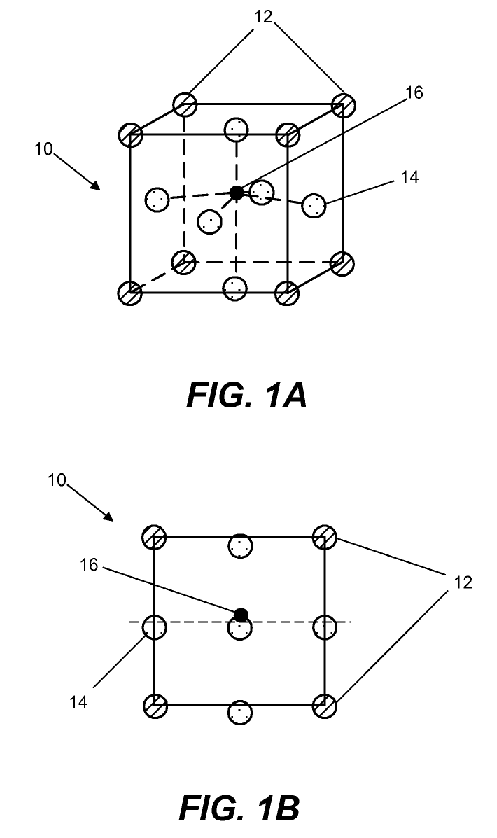

Referring to FIGS. 1A and 1B, a crystal of one form of PZT, lead titanate (PbTiO₃) is shown. The spontaneous polarization is a consequence of the positioning of the Pb²⁺, Ti⁴⁺, and O²⁻ ions within the unit cell 10. The Pb²⁺ ions 12 are located at the corners of the unit cell 10, which is of tetragonal symmetry (a cube that has been elongated slightly in one direction). The dipole moment results from the relative displacements of the O²⁻ and Ti⁴⁺ ions 14,16 from their symmetrical positions. The O²⁻ ions 14 are located near, but slightly below, the centers of each of the six faces, whereas the Ti⁴⁺ ion 16 is displaced upward from the unit cell 10 center. A permanent ionic dipole moment is associated with the unit cell 10. When lead titanate is heated above its ferroelectric Curie temperature, the unit cell 10 becomes cubic, and the ions assume symmetric positions

Ferroelectric films have been proposed as promising recording media, with a bit state corresponding to a spontaneous polarization direction of the media, wherein the spontaneous polarization direction is controllable by way of application of an electric field. A ferroelectric media or media stack can comprise one or more layers of patterned and/or unpatterned ferroelectric films. Ferroelectric media can achieve ultra high bit recording density because the thickness of a 180° domain wall in ferroelectric material is in the range of a few lattices (1-2 nm). However, it has been recognized that maintaining stability of the spontaneous polarization of the ferroelectric films may be problematic, limiting use of ferroelectric media in memory devices. It is proposed that bits can be created by writing small domains directly to a ferroelectric film having an as-grown polarization, but it is believed that bits written without consideration of the influence of the as-grown polarization on discrete domain polarization may have undesirably short retention time at room and elevated temperature.

In general, a ferroelectric film exhibits spontaneous, uniform, as-grown polarization either in the “UP” or “DOWN” direction. The ferroelectric film can be said to be asymmetrical because the bulk ferroelectric film is substantially uniform in polarization vector. As a result of this asymmetry, domains having an “UP” polarization defined within a portion of a bulk ferroelectric film having an as-grown polarization that is also in the “UP” direction will grow over some period of time and domains having a “DOWN” polarization defined within a portion of the same bulk ferroelectric film will shrink over some period of time (and vice versa in a bulk film having an opposite as-grown polarization). A domain may expand to affect neighboring domains, flipping written bits written to the neighboring domains, or a domain may contract to essentially flip the bit written to the domain from one state to the opposite state. The period of time over which an undesirable amount of domain inflation or deflation occurs may be undesirably short (i.e., failing retention specifications), and the domain (and bit) can be said to be unstable.

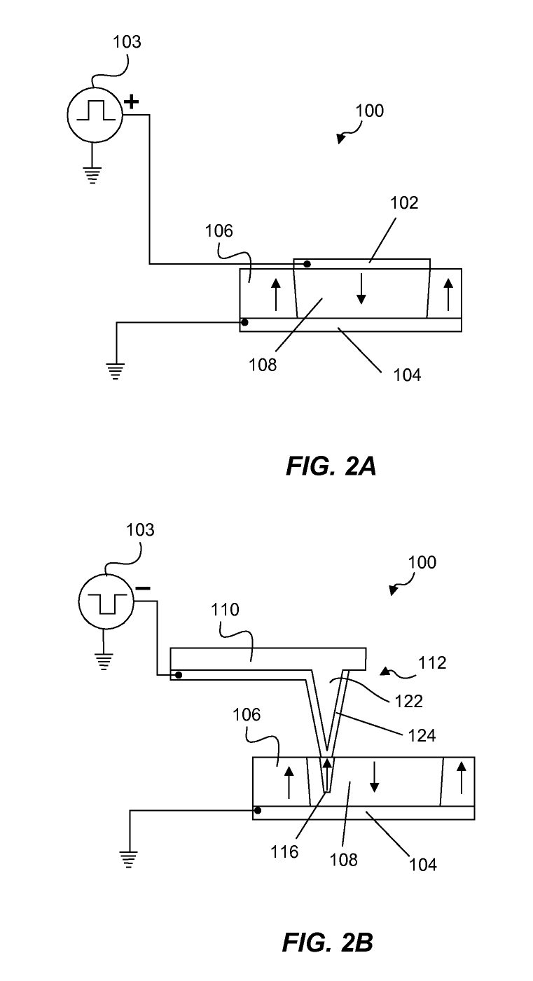

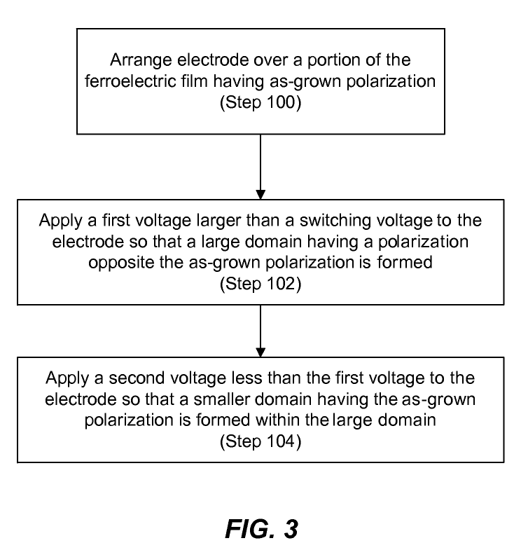

Embodiments of systems and methods in accordance with the present invention can be applied to improve the stability of domain polarization in a ferroelectric film. Referring to FIGS. 2A-3, an embodiment of a system 100 and method is shown comprising a write electrode 102 positioned in communicative proximity with a ferroelectric film 106 formed over a bottom electrode 104. The ferroelectric film 106 has an as-grown polarization vector oriented “UP” as indicated, although in other embodiments the as-grown polarization vector can be oriented “DOWN.” The write electrode 102 can prepare a portion of the ferroelectric film 106 for writing an “UP” bit that reduces an influence of the as-grown “UP” polarization of the bulk material. Preparation of a portion of the ferroelectric film 106 will be referred to herein as “poling,” and is achieved by positioning the write electrode 102 (Step 100) over the portion, or part of the portion, and applying a voltage (by way of a voltage source 103) larger than a polarization switching voltage to the write electrode 102 to polarize a large domain 108 whose polarization vector direction is opposite the ferroelectric film's as-grown polarization vector direction (Step 102). The write electrode 102 can be positioned by moving one or both of the write electrode 102 and the ferroelectric film 106 relative to the other. Once the portion of the ferroelectric film has been poled, a smaller domain can be formed by applying a smaller voltage with opposite polarity (relative to the larger voltage previously applied) so that a smaller domain within the larger domain is switched to have a polarization vector oriented in the same direction as the as-grown polarization (Step 104). The smaller voltage can be applied, for example, by a probe tip (referred to hereinafter as simply a tip) 112 or some other mechanism or device capable of forming a field confined within a footprint corresponding generally to a desired bit size. As shown in FIG. 2B, a tip 112 can comprise a conductive coating 124 formed over a non-conductive, or semi-conductive tip structure 122 (such as a silicon etched structure). Alternatively, the tip structure 122 can comprise a conductive material and may or may not include a conductive coating. The tip 122 is electrically connected with the voltage or current source 103.

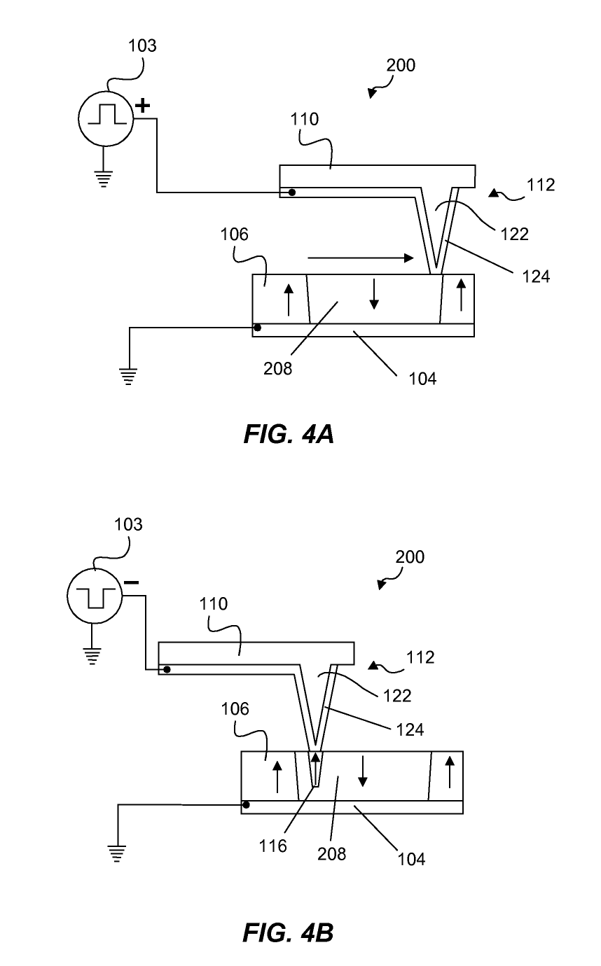

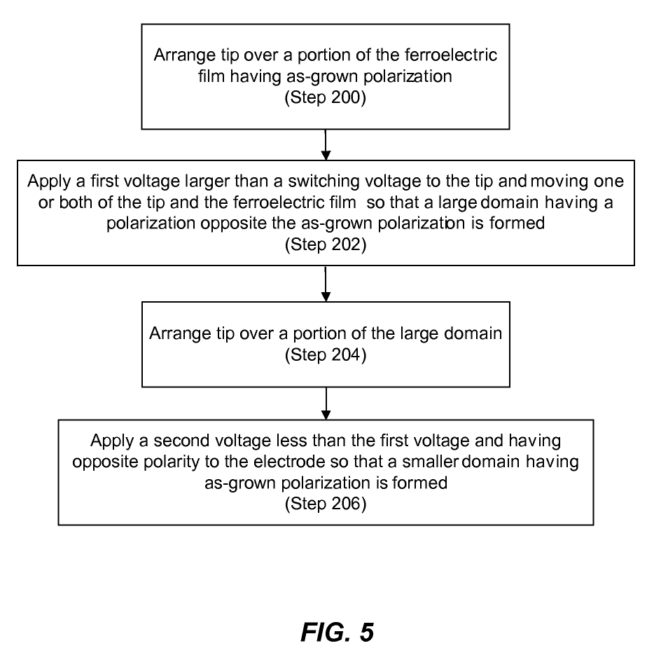

Referring to FIGS. 4A, 4B and 5, an alternative embodiment of a system 200 and method is shown comprising a tip 202 resembling the tip 112 of FIG. 2B used in substitution of an electrode and arranged in electrically communicative proximity with the ferroelectric film. As above, the ferroelectric film 206 has an as-grown polarization vector oriented “UP” as indicated, although in other embodiments the as-grown polarization vector can be oriented “DOWN.” The tip 202 can pole a portion of the ferroelectric film 206 by positioning the tip 202 over part of the portion (Step 200), applying a voltage larger than a switching voltage to the tip 202 and urging one or both of the tip 202 and the ferroelectric film 206 so that the tip passes along the portion such that a domain 208 having a polarization vector oriented “DOWN” (i.e., opposite the polarization vector direction of the bulk material) is formed within the portion (Step 202). A domain 208 is formed having a sufficient size to stabilize a follow-on domain. For example, the domain 208 can be 100× the areal size of a follow-on domain. Once the portion of the ferroelectric film has been poled, the tip 202 can be positioned over a desired location of the large domain 208 in which a bit is to be written (Step 204). A smaller domain 216 representing the bit can be formed by applying a smaller voltage with opposite polarity (relative to the initial poling voltage) to the tip 202 so that the smaller domain 216 within the larger domain (relative to the initial poling voltage) 208 is switched to have a polarization vector oriented in the same direction as the as-grown polarization (Step 206).

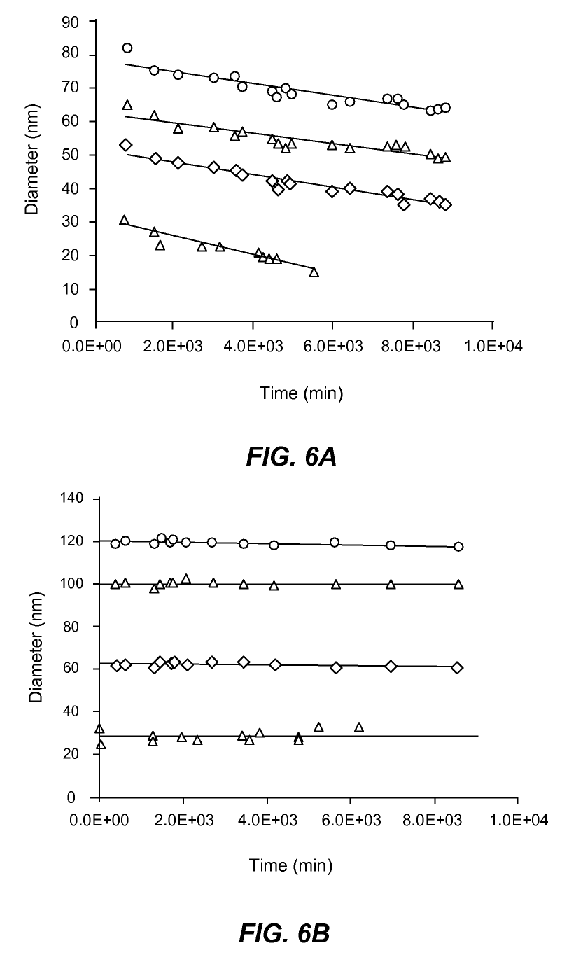

FIGS. 6A and 6B are plots illustrating bit retention characteristics. Bits were created in a ferroelectric film, and the diameters of the domains representing the bits were monitored over time using piezo-response Force Microscopy (PFM) techniques. FIG. 6A illustrates retention characteristics for bits written to a ferroelectric field using a bit writing technique that does not prepare portions of the ferroelectric film by poling. Bits having four different domain diameters were monitored over time (less than a week). As can be seen, there was shrinkage in domain diameter from between about 20% and 50%. FIG. 6B illustrates retention characteristics for bits written to a ferroelectric field using embodiments of methods and systems in accordance with the present invention. Portions of the ferroelectric film were prepared by poling and bits were formed within the poled portions (as described above). Bits having four different domain diameters were monitored over time (less than a week). As can be seen, very little shrinkage in domain diameter was observed.

Embodiments of methods and systems in accordance with the present invention can provide improved bit retention by improving stability of domains having polarization vector directions that correspond to the polarization vector direction of the bulk ferroelectric film. Further, it is proposed that embodiments of methods and systems in accordance with the present invention can be applied to write bits having sufficiently long retention time (i.e., satisfying current retention specifications) even at temperature as high as 200 C.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A memory device comprising:
a ferroelectric media comprising at least one ferroelectric film;
wherein the ferroelectric film has an as-grown spontaneous polarization of a first direction;
a tip adapted to electrically communicate with the ferroelectric film; and
circuitry to write a bit having a spontaneous polarization of the first direction, the circuitry adapted to:
position the tip;
apply a first voltage to the tip larger than a switching voltage of the ferroelectric film;
move one or both of the tip and the ferroelectric media to form a first domain having a spontaneous polarization of opposite the first direction;
position the tip over the first domain; and
apply a second voltage to the tip smaller than the first voltage to form a second domain smaller than the first domain and having a polarization of the first direction, the second domain defining the bit.

2. The memory device of claim 1 wherein, the at least one ferroelectric film includes one or more of lead zirconate titanate, strontium ruthenate, and strontium titanate.

3. A method of writing a bit in a ferroelectric film having a spontaneous polarization with a same direction as an as-grown spontaneous polarization of the ferroelectric film comprising:
positioning a tip in electrically communicative proximity with the ferroelectric film;
applying a first voltage to the tip larger than a switching voltage of the ferroelectric film;
moving one or both of the tip and the ferroelectric film to form a first domain having a spontaneous polarization of opposite a direction of the as-grown spontaneous polarization;
positioning the tip over the first domain; and
applying a second voltage to the tip smaller than the first voltage to form a second domain smaller than the first domain and having a spontaneous polarization of the direction of the as-grown spontaneous polarization, the second domain defining the bit.

4. A memory device comprising:
a ferroelectric media comprising at least one ferroelectric film;
wherein the ferroelectric film has an as-grown spontaneous polarization of a first direction;
an electrode adapted to electrically communicate with the ferroelectric film;
a tip adapted to electrically communicate with the ferroelectric film; and
circuitry to write a bit having a spontaneous polarization of the first direction, the circuitry adapted to:
position the electrode;
apply a first voltage to the electrode larger than a switching voltage of the ferroelectric film to form a first domain having a spontaneous polarization of opposite a direction of the as-grown spontaneous polarization; and
position the tip over a portion of the ferroelectric film within the first domain;
apply a second voltage to the tip smaller than the first voltage to form a second domain smaller than the first domain and having a polarization of the first direction, the second domain defining the bit.

5. The memory device of claim 4, wherein the at least one ferroelectric film includes one or more of lead zirconate titanate, strontium ruthenate, and strontium titanate.

6. A method of writing a bit in a ferroelectric film having a spontaneous polarization with a same direction as an as-grown spontaneous polarization of the ferroelectric film comprising:
positioning an electrode in electrically communicative proximity with the ferroelectric film;
applying a first voltage to the electrode larger than a switching voltage of the ferroelectric film to form a first domain having a spontaneous polarization of opposite a direction of the as-grown spontaneous polarization;
positioning a tip in electrically communicative proximity with the ferroelectric film at a portion of the ferroelectric within the first domain; and
applying a second voltage to the tip smaller than the first voltage to form a second domain smaller than the first domain and having a spontaneous polarization of the direction of the as-grown spontaneous polarization, the second domain defining the bit.
